(19) United States
(12) Patent Application Publication
(10) Pub. No.: US 2024/0199944 A1
(43) Pub. Date: Jun. 20, 2024

(54) Fracturing Fluid with Superior Proppant Transport Capability

(71) Applicants: CNPC USA Corporation, Houston, TX (US); Beijing Huamei, Inc., Beijing (CN); China National Petroleum Corporation, Beijing (CN)

(72) Inventors: Genyao Lin, The Woodlands, TX (US); Jiangshui Huang, Sugar Land, TX (US); Fuchen Liu, Panjin (CN); Jianshen Li, Houston, TX (US); Lijun Lin, Katy, TX (US)

(73) Assignees: CNPC USA Corporation, Houston, TX (US); Beijing Huamei, Inc., Beijing (CN); China National Petroleum Corporation, Beijing (CN)

(21) Appl. No.: 18/074,149

(22) Filed: Dec. 2, 2022

(51) Int. Cl. C09K 8/60; C08F 220/56; C09K 8/68; C09K 8/80

(52) U.S. Cl. CPC C09K 8/604; C08F 220/56; C09K 8/68; C09K 8/80; C08F 2800/20

(57) ABSTRACT

A water-soluble polymer system for suspending proppant in a fracturing fluid is disclosed herein. The polymer system can be made with acrylamide, acrylic acid, a surfactant monomer, urea, a glycol ether, sodium hydroxide, and water and when mixed in a fracturing fluid with a proppant can form three-dimensional structures by hydrophobic association. The structures can suspend a proppant for a period of days in comparison with traditional fracturing fluid systems with similar concentrations.

### FIELD OF THE INVENTION

This disclosure relates generally to fracturing fluid formulations and more specifically to fracturing fluids with high proppant transport and suspension properties.

### DESCRIPTION OF THE PRIOR ART

Hydrocarbons such as oil and gas may be produced from wells that are drilled into hydrocarbon reservoirs. For reservoirs that are of low permeability or with formation damage, the flow of the hydrocarbon into the production wells may be undesirably low. In these cases, the wells are often stimulated by hydraulic fracturing operations. For hydraulic fracturing treatment, a pad, which is a viscous fluid free of proppants, is first pumped at a rate and pressure high enough to break down the formation and create fractures. A fracturing fluid (carrying fluid) is then pumped to transport proppants such as sand and ceramic particles into the fractures. The proppants are used to keep the fractures open for the hydrocarbons to flow into the wellbore for recovery.

Proppant carrying capacity is one of the most important properties of the fracturing fluid. A fracturing fluid with high proppant transport capabilities may transport more proppant into the fractures. This can also allow the proppants to be carried further away from the wellbore to increase production. A major limitation with traditional slickwater fracturing fluid is reduced proppant transport capability.

Traditionally, high viscosity friction reducers (HVFRs) have been used to increase the proppant carrying capabilities of a fracturing fluid. This is due to the potential of reduced costs and improved retained conductivity. However, the use of HVFRs can result in the undesirable tradeoff of reduced fracturing length and fewer secondary fractures when compared to the use of linear guar at similar cost-based concentrations. Additionally, proppant transport capacity may still be limited with these techniques because the HVFR based fracturing fluid can only suspend proppant for seconds to minutes depending on the proppant size and density.

Other solutions to this limitation have been to include a swellable crosslinked polyacrylamide into the fracturing fluid. This can require relatively high concentrations of micro-gel fragments to provide sufficient proppant suspension.

Associative polymer systems have also been used for proppant suspension. These system use traditional micellar polymerization methods with commonly used key sodium lauryl sulfate as an anionic surfactant to solubilize the insoluble hydrophobic monomer within its micelles in aqueous media. The insoluble hydrophobic monomer can be incorporated into the polymer backbone as blocks. However, only a surfactant like monomer or surfmer can be used that is also water soluble. Due to the presence of a critical micelle concentration (CMC) of the surfactant monomer, the polymer contains some surfactant monomers that are individually incorporated into the polymer backbone and other surfactant monomers which initially form micelles and can be added to the polymer backbone as blocks. This can result in a hybrid and differing polymer structure. Therefore, there is a need in the art for fracturing fluids with high proppant transport capabilities without limiting the fracturing properties of the fracturing fluid.

### SUMMARY

A first embodiment of the present invention provides for a polymer and fracturing fluid. The polymer can include a surfactant monomer, hydrophilic monomer, and a glycol ether. In some embodiments, the surfactant monomer can include poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, and combinations thereof.

In other embodiments the hydrophilic monomer can include acrylate salts, acrylate, acrylamide, 2-acrylamido-2-methylpropane sulfonic acid salts, 2-acrylamido-2-methylpropane sulfonic acid, and combinations thereof. The glycol ether can include tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, tripropylene glycol methyl ether, and combinations thereof.

In some embodiments the polymer can further include urea present in concentrations from about 1 to 10 weight percent in the polymer. The surfactant monomer can be present in concentrations from about 0.5 to 5.0 weight percent in the polymer. The hydrophilic monomer can be present in concentrations from about 10 to 25 weight percent of the polymer. The glycol ether can be tripropylene glycol methyl ether and can be present in concentrations from about 1.0 to 10 weight percent of the polymer.

In some embodiments, the polymer can also include Na₄EDTA, PCA Dimethicone, a persulfate, sodium metabisulfite, and V-50. The Na₄EDTA, PCA Dimethicone, persulfate, sodium metabisulfite, and V-50 can be present in less than 1 weight percent each of the polymer. The persulfate can be a sodium persulfate, a potassium persulfate, an ammonium persulfate, or combinations thereof. In an embodiment, the sodium metabisulfite can be replaced by another reducing agent such as hydroxymethanesulfinic acid monosodium salt.

In alternate embodiments, the surfactant monomer can have one of the following structures where m is between 1 and 30 and n is between 1 and 50:

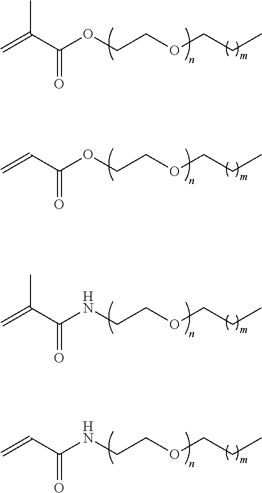

A second embodiment of the present technology provides for a method of making a polymer composition. The method can include steps of mixing raw ingredients together, adjusting the pH, cooling the mixture, purging the mixture with nitrogen, adding an initiator and reacting the mixture, and cutting, drying, grinding, and sieving the resulting get into a powder. In some embodiments, the raw ingredients can comprise acrylamide, acrylic acid, urea, a glycol ether, a surfactant monomer, and water.

In some embodiments, the mixture can also include Na₄EDTA and PCA Dimethicone. The pH of the mixture can be adjusted by sodium hydroxide to about 4.0 to 8.5. The reactor can be cooled to about 10 to 25 degrees Celsius. The reactor can further be purged for about 15 to 60 minutes.

In some embodiments, the initiator can be a persulfate, sodium metabisulfite, V-50, or combinations thereof. The persulfate can be a sodium persulfate, a potassium persulfate, an ammonium persulfate or combinations thereof.

### BRIEF DESCRIPTION OF DRAWINGS

The present technology will be better understood on reading the following detailed description of non-limiting embodiments thereof, and on examining the accompanying drawings, in which:

FIG. 1 is a method of manufacturing a polymer according to an embodiment of the present technology.

FIG. 2 is a method of using a polymer to increase proppant suspension in a fracturing fluid according to an embodiment of the present technology.

FIGS. 3A-3F are exemplary embodiments comparing proppant suspension in a fracturing fluid with the present technology and traditional methods over various periods of time.

### DETAILED DESCRIPTION

The foregoing aspects, features, and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment,” “an embodiment,” “certain embodiments,” or “other embodiments” of the present invention are not intended to be interpreted as excluding the existence of additional embodiments that also incorporate the recited features. Furthermore, reference to terms such as “above,” “below,” “upper,” “lower,” “side,” “front,” “back,” or other terms regarding orientation are made with reference to the illustrated embodiments and are not intended to be limiting or exclude other orientations.

The present technology provides for a fracturing fluid based on a water-soluble polymer system with a degradable surfactant monomer. The disclosed associative polymer system can form three-dimensional network in water with sufficient hydration kinetics to greatly enhance its proppant transport capability. As compared to HVFR systems which require high viscosity to carry proppants, the disclosed fracturing fluid can have a low viscosity and suspend proppants for extended periods of time. The system can form three-dimensional structures facilitated by hydrophobic association. This can enhance proppant transport capabilities of a fracturing fluid. This can also require less water usage resulting in lower environmental impact. The fracturing fluid can be capable of suspending proppant for up to days as compared with traditional methods at comparable concentrations.

In an aspect, the present disclosure provides a composition including at least one surfactant monomer or surfmer having a structure of:

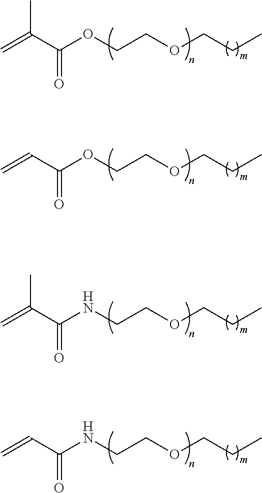

In the above exemplary surfmers, n can be any number ranging from 1 to 50 and m can be any number from 1 to 30. Other exemplary surfmers can include poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, and combinations thereof. In some embodiments, the composition includes the surfactant monomer in an amount from about 0.5 wt % to 5 wt % based on the total weight of the composition.

The composition can further include at least one hydrophilic monomer selected from acrylate salts, acrylate, acrylamide, 2-acrylamido-2-methylpropane sulfonic acid salts, 2-acrylamido-2-methylpropane sulfonic acid, and combinations thereof. The hydrophilic monomer can be present in an amount from about 10 wt % to 25 wt % of the total weight of the composition.

The composition can further include at least one glycol ether. The glycol ether can comprise one or more of tripropylene glycol methyl ether, triethylene glycol methyl ether, diethylene glycol n-butyl ether, diethylene glycol monobutyl ether, dipropylene glycol n-butyl ether, propylene glycol phenyl ether, ethylene glycol hexyl ether, diethylene glycol hexyl ether, ethylene glycol phenyl ether, diethylene glycol ethyl ether, and combinations thereof. In some embodiments, the glycol ether is tripropylene glycol methyl ether. In some embodiments, the composition can include about 1 wt % to 10 wt % of glycol ether based on the total weight of the composition.

In some embodiments, the composition can further include urea with concentrations in the range of 1 wt % to 10 wt % of the polymer composition.

In some embodiments, the composition can further include an acrylic acid with concentrations in the range of 1 wt % to 15 wt %.

In some embodiments, the composition can further include sodium hydroxide with concentrations of 3 wt % to 10 wt %.

In some embodiments, the composition can further include Na₄ EDTA with concentrations in the range of up to about 0.05 wt %.

In some embodiments, the composition can further include water with concentrations of 40 wt % to 60 wt %.

In some embodiments, the composition can further include PCA Dimethicone with concentrations of up to about 0.05 wt %.

In some embodiments, the composition can further include a persulfate. The persulfate can be a sodium persulfate, a potassium persulfate, an ammonium persulfate, and combinations thereof. The persulfate can be included at concentrations from about 0.01 wt % to 0.5 wt % of the composition.

In some embodiments, the composition can further include sodium metabisulfite. In other embodiments, this can be a hydroxymethanesulfinic acid monosodium salt. In embodiments, these can comprise from 0.01 wt % to 0.5 wt % of the composition.

In some embodiments, the composition can further include V-50 with concentrations of 0.1 wt % to 0.5 wt %.

This polymer-based fluid can form a three-dimensional network with sufficient hydration kinetics to greatly increase proppant transport capacity.

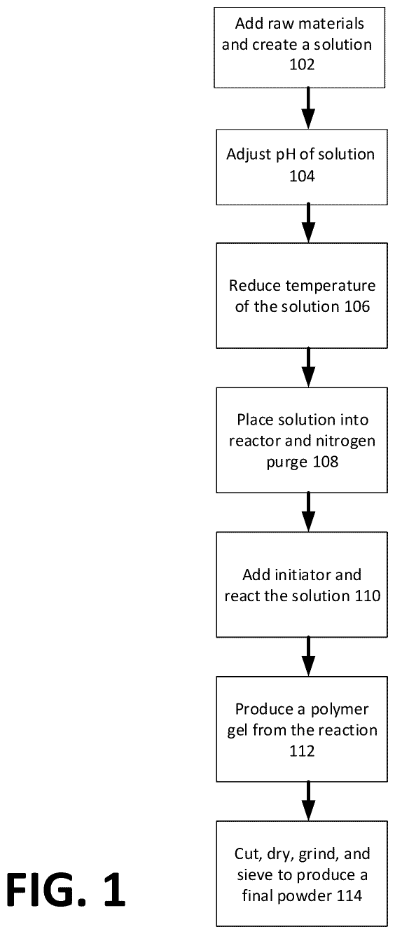

FIG. 1 depicts a method of manufacturing a polymer for increased proppant capacity in a fracturing fluid according to an embodiment of the present technology. In step 102, initial raw materials can be mixed together in solution until the solids are dissolved. The present disclosure will further be described by the exemplary raw materials and weight percentages as listed in Table 1. However, it is to be understood that alternative raw materials and weight percentages may be used in alternative embodiments of the disclosure.

TABLE 1

| | Weight Percent of | |
|---|---|---|
| Raw Material | Raw Materials | |
| Acrylamide | 17 | wt % |
| Acrylic Acid | 7.5 | wt % |
| 50% Poly(ethylene glycol) behenyl ether | 1 | wt % |
| methacrylate (MW 1500) | | |
| 50% Sodium hydroxide | 7.75 | wt % |
| Na₄EDTA | 0.01 | wt % |
| Urea | 5 | wt % |
| Tripropylene glycol methyl ether | 3 | wt % |
| Water | 58.37 | wt % |
| PCA Dimethicone | 0.01 | wt % |
| 2% Sodium persulfate | 0.05 | wt % |
| 4% Sodium metabisulfite | 0.06 | wt % |
| 10% V-50 | 0.25 | wt % |

In step 104, the pH of the solution can be adjusted to about 4.0 to 8.5, preferably to about 5 to 6.5. This can be done with sodium hydroxide. During this time, the temperature can be controlled under 30 degrees Celsius. The mixture can be further cooled to about 10 to 25 degrees Celsius in step 106. In step 108, the mixture can be placed into a reactor. The reactor can be nitrogen purged for about 15-60 minutes. In step 110, the initiators can be added to the mixture to start the reaction. In the present embodiment, the one or more initiators can include sodium persulfate, sodium metabisulfite, and V-50. The reaction can be allowed to proceed without cooling. When complete, a polymer gel can be produced in step 112. The gel can be cut, dried, grinded, and sieved in step 114 to produce a final dry powder.

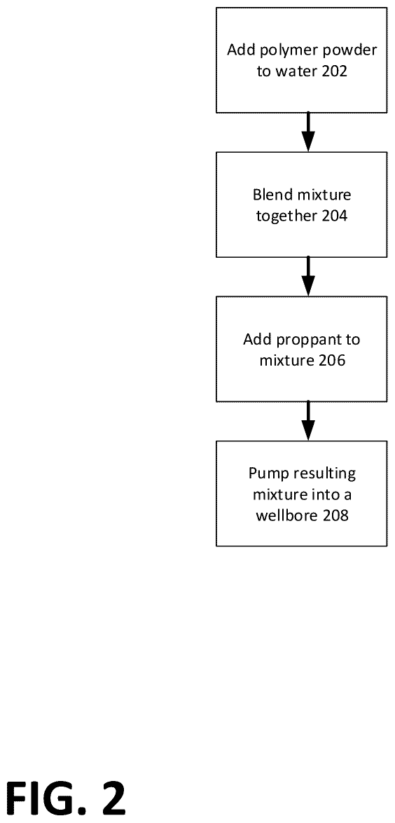

Proppant suspension testing of fracturing fluid. FIG. 2 provides for a method of using the polymer to increase proppant suspension in a fluid. In an embodiment, polymer powder is added to 0.5K TDS water at a 0.004 weight ratio of the polymer powder to fracturing fluid in step 202. The polymer powder weight ratio to fracturing fluid can range from 0.002 to 0.01 in alternate embodiments. The fracturing fluid and polymer powder can then be mixed in step 204. The mixing can occur with a blender at 2000 rpm for about 4 minutes. In step 206, proppant can be added to the mixture. The proppant can be added to the mixture at about a 1:4 weight ratio of proppant to fluid. The ratio of the proppant to fluid can be 1:10 to 1:2. The proppant can be a 20/40 mesh or other appropriate sizes such as 40/70, 70/140 etc.

The resulting mixture can then be pumped into a wellbore for fracturing operations in step 208. The use of the polymer can allow for the suspension of greater amounts of proppant during the fracturing operations. This can result in greater fracturing lengths and more secondary fractures than traditional fracturing fluids used in similar concentrations. In the present exemplary embodiment, the viscosity of the fluid measured at a shear rate of 511 S⁻¹ can be of greater than about 20 cp, of greater than about 30 cp, of greater than about 40 cp, of greater than about 50 cp, of greater than about 60 cp, of greater than about 70 cp, of greater than about 80 cp, of greater than about 90 cp. In general, the fracturing fluid can have a viscosity of less than 100 cp at a shear rate of 511 S⁻¹.

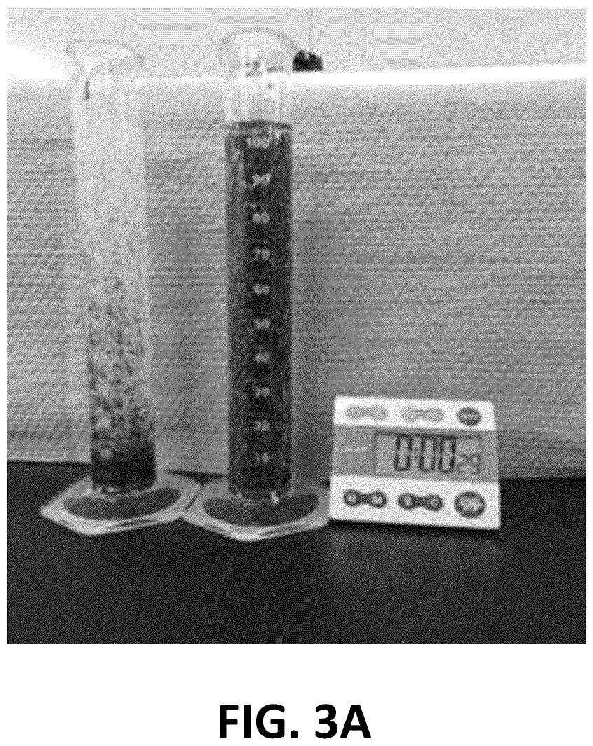

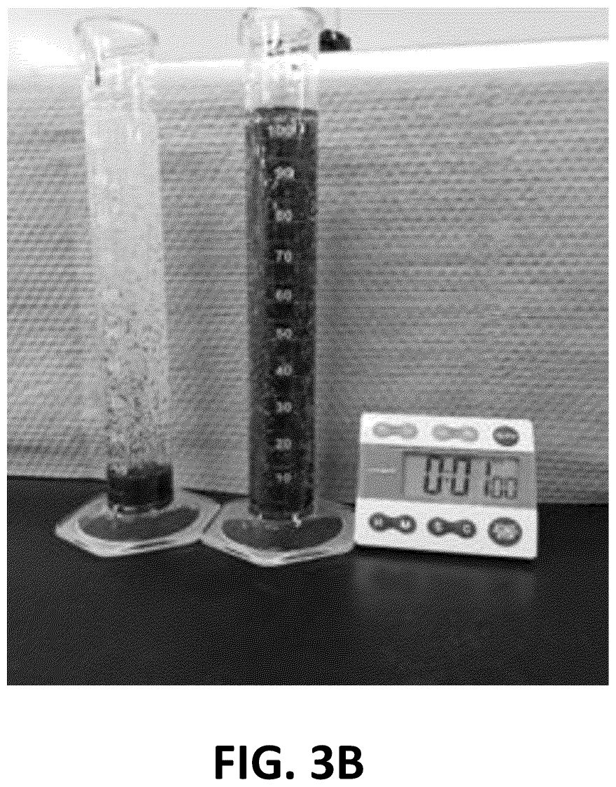

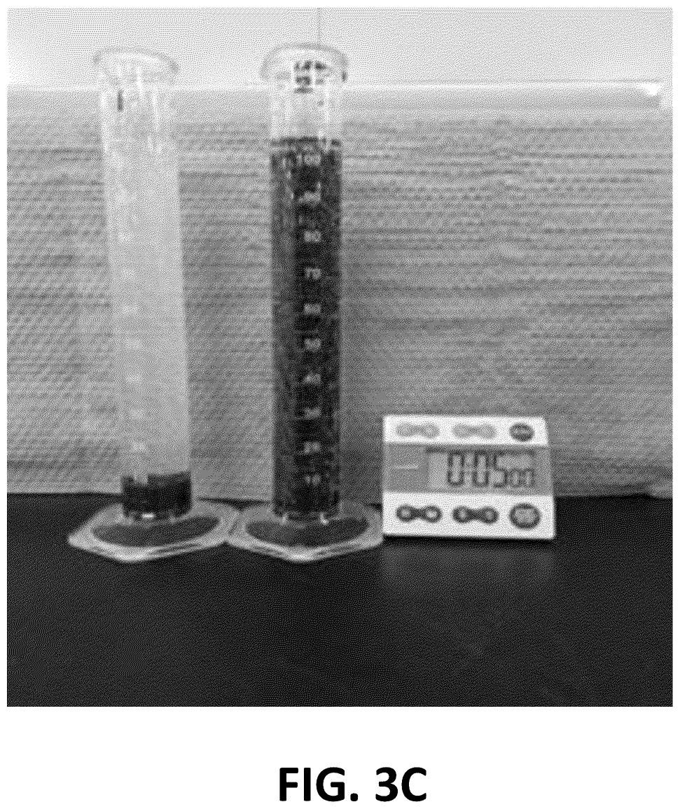

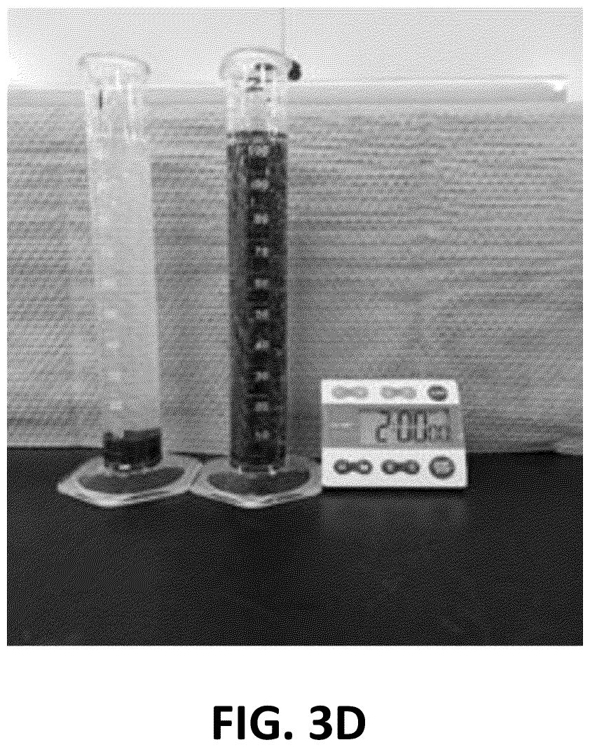

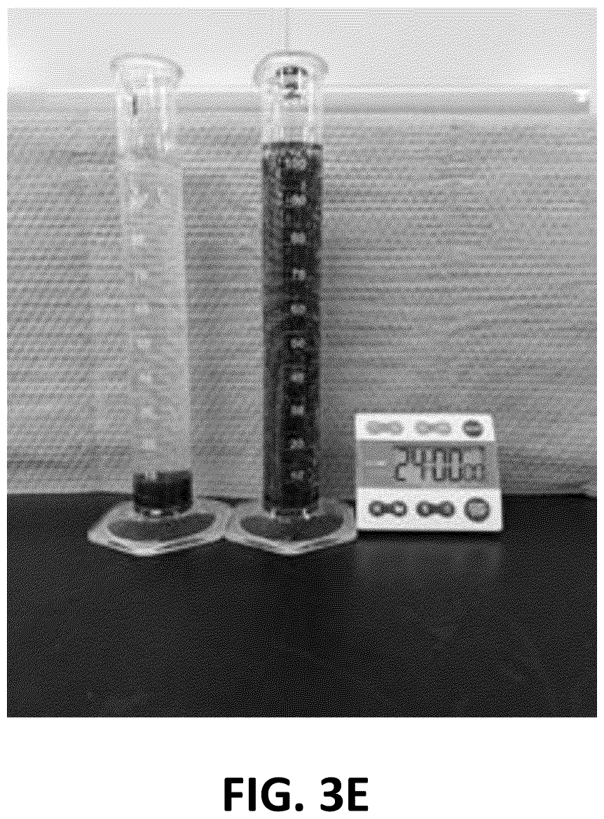

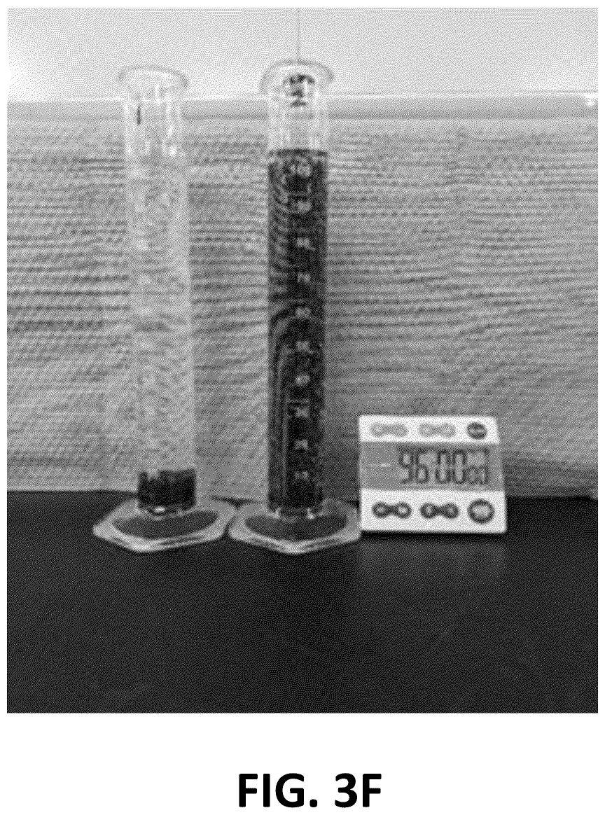

FIGS. 3A-F depict proppant settling comparisons over different time intervals. The column shown on the left uses a traditional powder friction reducer and the column on the right uses the polymer powder of the present technology. Intervals shown are 30 seconds in FIG. 3A, 1 minute in FIG. 3B, 5 minutes in FIG. 3C, 2 hours in FIG. 3D, 24 hours in FIG. 3E, and 96 hours in FIG. 3F. The figures show how the polymer settles quickly in the traditional friction reducer while remaining suspended for multiple days with the polymer of the present technology.

Although the technology herein has been described with reference to embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A polymer and fracturing fluid wherein the polymer comprises:
at least one surfactant monomer, wherein the surfactant monomer comprises poly(ethylene glycol) behenyl ether methacrylate or acrylate, poly(ethylene glycol) behenyl ether (meth)acrylamide, poly(ethylene glycol) lauryl methacrylate or acrylate, poly(ethylene glycol) lauryl (meth)acrylamide, poly(ethylene glycol) stearyl methacrylate or acrylate, poly(ethylene glycol) stearyl (meth)acrylamide, poly(ethylene glycol) cetyl methacrylate or acrylate, poly(ethylene glycol) cetyl (meth)acrylamide, poly(ethylene glycol) erucyl (meth)acrylate, poly(ethylene glycol) erucyl (meth)acrylamide, or combinations thereof;
at least one hydrophilic monomer, wherein the hydrophilic monomer comprises acrylate salts, acrylate, acrylamide, 2-acrylamido-2-methylpropane sulfonic acid salts, 2-acrylamido-2-methylpropane sulfonic acid, or combinations thereof; and
at least one glycol ether; wherein the glycol ether comprises tripropylene glycol methyl ether, triethylene glycol methyl ether, diethylene glycol monobutyl ether, propylene glycol phenyl ether, ethylene glycol hexyl ether, ethylene glycol phenyl ether, or combinations thereof; and
wherein the polymer is formed without the use of micellar polymerization employing a surfactant to dissolve a hydrophobic monomer; and
wherein the polymer is powder.

2. The polymer of claim 1 further comprising urea with concentrations in the range of about 1 to 10 weight percent of the polymer composition.

3. The polymer of claim 1 wherein the at least one surfactant monomer comprises about 0.5 to 5 weight percent of the polymer composition.

4. The polymer of claim 1 wherein the at least one hydrophilic monomer comprises about 10 to 25 weight percent of the polymer composition.

5. The polymer of claim 1 wherein the at least one glycol ether comprises about 1 to 10 weight percent of the polymer composition.

6. The polymer of claim 1 further comprising Na4EDTA, PCA Dimethicone, a persulfate, sodium metabisulfite, and V-50.

7. The polymer of claim 6 wherein the Na4EDTA, PCA Dimethicone, persulfate, sodium metabisulfite, and V-50 comprise less than 1 weight percent of the polymer composition each.

8. The polymer of claim 6 wherein the persulfate comprises a sodium persulfate, a potassium persulfate, an ammonium persulfate, or combinations thereof.

9. The polymer of claim 6 wherein the sodium metabisulfite is a hydroxymethanesulfinic acid monosodium salt.

10. The polymer of claim 6 wherein the surfactant monomer has a structure comprising one or more of: 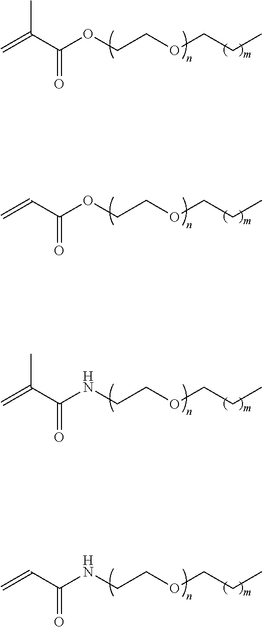
wherein m is between 1 and 30 and n is between 1 and 50.

11. A method of making a polymer composition comprising:
mixing raw ingredients comprising a hydrophilic monomer, acrylic acid, urea, a glycol ether, a surfactant monomer, and water;
adjusting a pH of the mixture;
cooling the mixture;
purging the mixture in a reactor with nitrogen;
adding an initiator and reacting the mixture to produce a polymer gel; and
cutting, drying, grinding, and sieving the polymer gel into a powder.

12. The method of claim 11 wherein the mixture further comprises Na4EDTA and PCA Dimethicone.

13. The method of claim 11 wherein the sodium hydroxide adjusts the pH to about 4.0-8.5.

14. The method of claim 11 wherein the reactor is cooled to about 10 to 25 degrees Celsius.

15. The method of claim 11 wherein the reactor is purged for about 15-60 minutes.

16. The method of claim 11 wherein the initiator comprises a persulfate, sodium metabisulfite, V-50, or combinations thereof.

17. The method of claim 16 wherein the persulfate comprises a sodium persulfate, a potassium persulfate, an ammonium persulfate, or combinations thereof.

18. A method of using the polymer to increase proppant suspension in a fluid comprising adding polymer powder to 0.5K TDS water at a 0.002 to 0.01 weight ratio of the polymer powder to fracturing fluid;
mixing the fracturing fluid and polymer powder to form a mixture;
adding proppant to the mixture at about 1:10 to 1:2 weight ratio of proppant to fluid to form a resulting mixture; and
pumping the resulting mixture into a wellbore for a fracturing operation.

19. The method of claim 18 wherein the weight ratio of the polymer powder to fracturing fluid is 0.004.

20. The method of claim 18 wherein the proppant is added to the mixture at about a 1:4 weight ratio of proppant to fluid.
